(19) United States
(12) Patent Application Publication
(10) Pub. No.: US 2004/0215114 A1
(43) Pub. Date: Oct. 28, 2004

(54) Stretching, strengthening and massage apparatus

(76) Inventor: Joseph Cruz, La Mesa, CA (US)

Correspondence Address: Karl M. Steins, Steins & Associates, Suite 120, 2333 Camino del Rio South, San Diego, CA, 92108, US

(21) Appl. No.: 10/830,887

(22) Filed: Apr. 22, 2004

Related U.S. Application Data
(60) Provisional application No. 60/465,709, filed on Apr. 26, 2003.

(51) Int. Cl. A61H 7/00; A61H 15/00

(52) U.S. Cl. 601/132; 601/129; 601/1; 601/137; 601/143

(57) ABSTRACT

A Stretching, Strengthening and Massage Apparatus is disclosed. Also disclosed is a device that employs a spherical device for aiding in Massage of bodily areas. The device further has an elongate strap defined by several loops along its length to be used as handholds when stretching or exercising. The device is further usable as an exercise device by simple engagement with a conventional door. The spherical member is preferably formed with bumps on its outer surface to further improve its utility as a massage device.

This application is filed within one year of, and claims priority to Provisional Application Ser. No. 60/465,709, filed Apr. 26, 2003.

### BACKGROUND OF THE INVENTION

1. Field of the Invention

This invention relates generally to therapeutic devices and, more specifically, to a Stretching, Strengthening and Massage Apparatus

2. Description of Related Art

There are a variety of portable exercise and fitness devices available on the market today for toning virtually every muscle group on the body. There are also a variety of massaging and stretching devices to assist a person in massaging tight or injured muscle areas and/or to stretch out tight muscles. The problem is that there is no single device that can adequately provide all of these benefits and yet be compact and portable.

### SUMMARY OF THE INVENTION

In light of the aforementioned problems associated with the prior devices and methods, it is an object of the present invention to provide a Stretching, Strengthening and Massage Apparatus. The device should employ a spherical device for aiding in Massage of bodily areas. The device should further have an elongate strap defined by several loops along its length to be used as handholds when stretching or exercising. The device should further be usable as an exercise device by simple engagement with a conventional door. The spherical member should be formed with bumps on its outer surface to further improve its utility as a massage device.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a side view of a preferred embodiment of the stretching, strengthening and massage apparatus of the present invention;

FIGS. 2A and 2B are cutaway side and front views, respectively, of the spherical member of the apparatus of FIG. 1;

FIG. 3 is a perspective view of one assembly-half of the apparatus of FIG. 1;

FIG. 4 is a back view of a user employing the apparatus of FIG. 1 to massage;

FIG. 5 is a back view of a user employing the apparatus of FIG. 1 to stretch; and

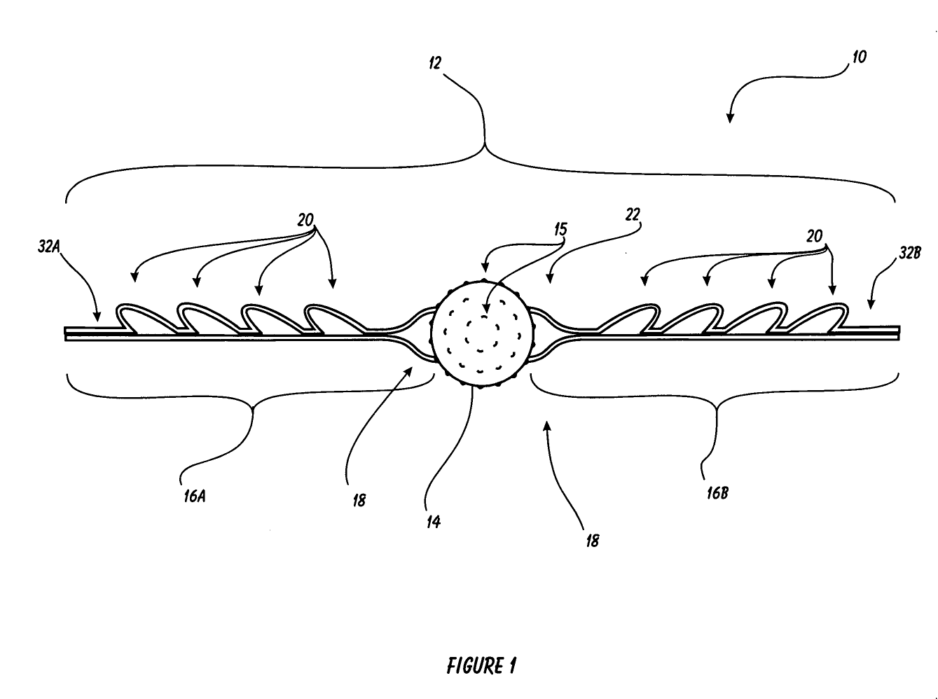

FIG. 4 is a side view of the device of FIG. 1 as it might be used as a strengthening device.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Stretching, Strengthening and Massage Apparatus.

The present invention can best be understood by initial consideration of FIG. 1. FIG. 1 is a side view of a preferred embodiment of the stretching, strengthening and massage apparatus 10 of the present invention. The apparatus 10 comprises two major components, a spherical member 14 attached to the center of a strap assembly 12. The spherical member 14 is preferably made from a solid, relatively hard, rubberized material, and has a plurality of rounded bumps 15 disposed across its outer surface.

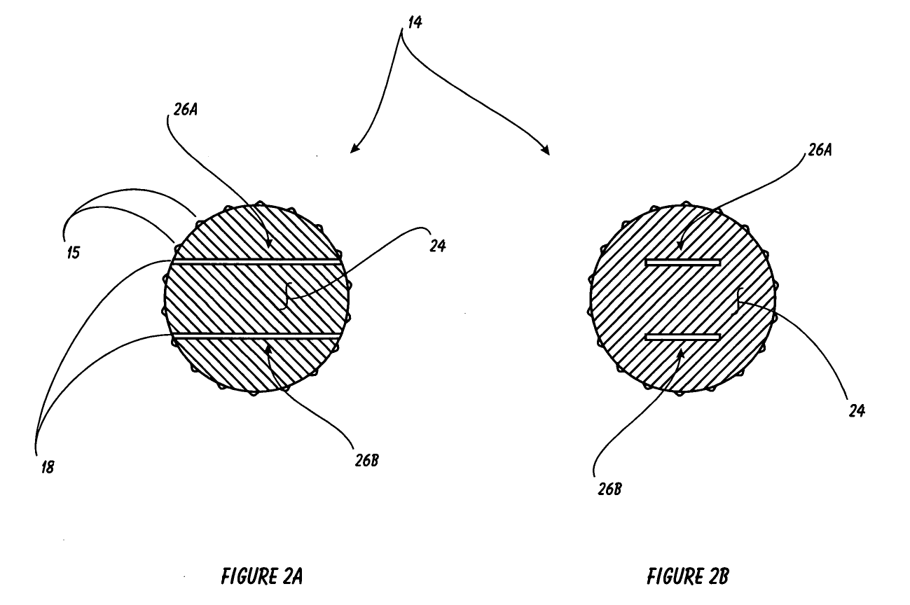

The strap assembly 12 is made from a first assembly-half 16A and a second assembly-half 16B, which are interconnected at a central loop 22. Each assembly-half 16 comprises a plurality of strap loops 20 in spaced relation along its length. The central loop 22 preferably passes through the spherical member 14 at apertures 18 formed in the outer surface of the spherical member 14. Now turning to FIGS. 2A and 2B, we can more closely examine the ball structure.

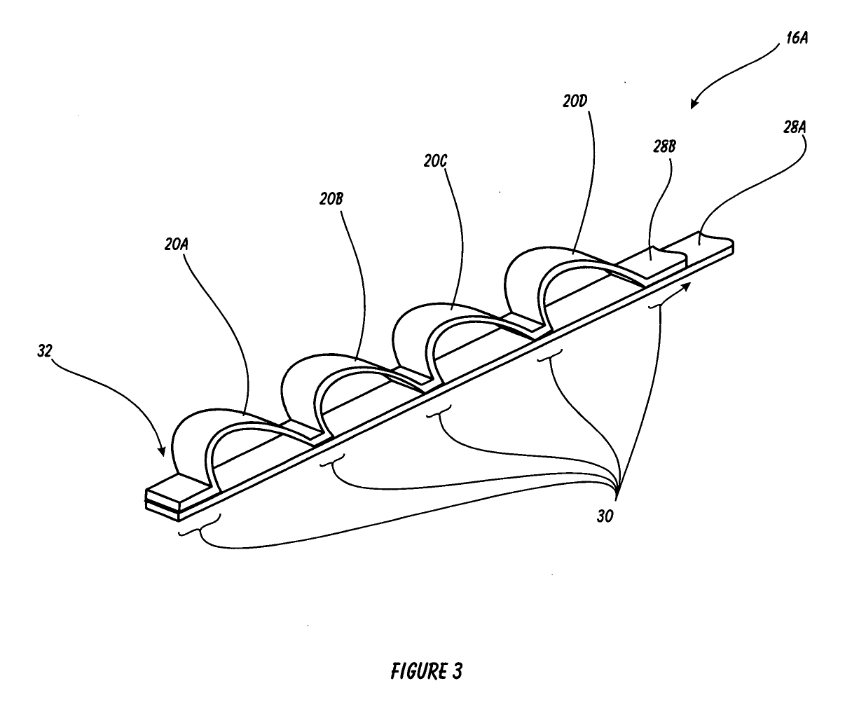

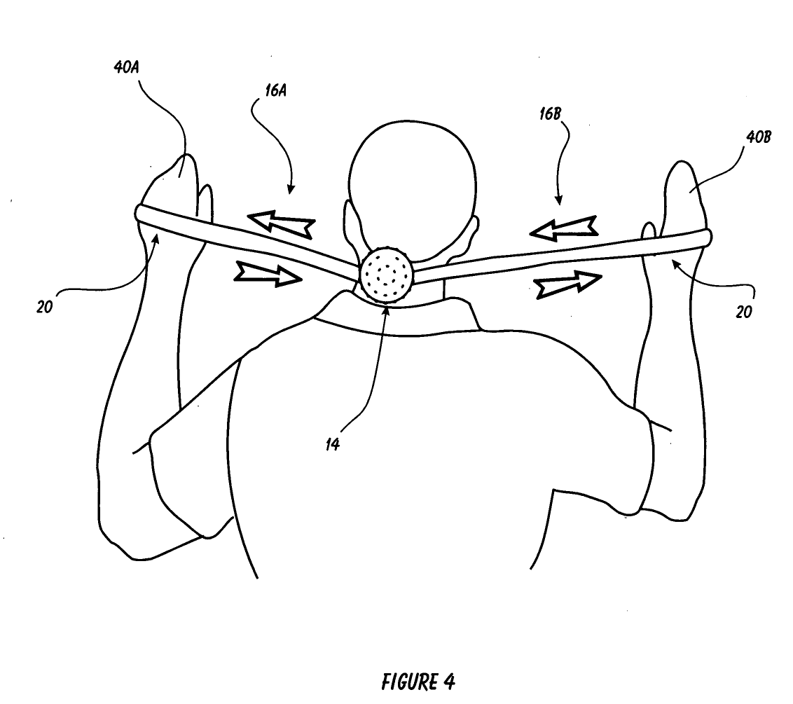

FIGS. 2A and 2B are cutaway side and front views, respectively, of the spherical member 14 of the apparatus of FIG. 1. The spherical member 14 is made with a substantially solid core 24 having one or more strap bores 26A, 26B passing through it. The outer surface of the member 14 will have a plurality of rounded bumps 15 dispersed on it to provide additional stimulation when being used for massage. Where the strap assembly (see FIG. 1) is made from flat straps, the two strap bores 26A and 26B will have a thin, rectangular cross-section (See FIG. 2A) to permit the strap elements to pass therethrough (i.e. the two straps making up the central loop). The spherical member 14 can be provided in a variety of different sizes and/or shapes; in this version, it is approximately 2½ inches in diameter, with the strap bores 26 being approximately 1 inch wide and 1/16 inch high (to accommodate this particular size and shape of strap). The spherical member 14 could be made from rubber, silicone, as well as other natural or man-made and non-rubberized materials, such as wood, metal or plastic. If we turn now to FIG. 3, we can examine the details regarding the strap assembly.

FIG. 3 is a perspective view of the first assembly-half 16A of the apparatus of FIG. 1. The second assembly-half (element 16B) is the mirror image of the structure depicted in this drawing figure. Both assembly-halves 16 are made from a first strap element 28A and a second strap element 28B bonded to one another along their lengths at mated portions 30. In between each mated portion 30, the second strap element 28B has additional slack built in to form a plurality of loops 20 within the assembly-half 16A. In this embodiment, there are first, second, third and fourth loops 20A-20D, but in other designs, other numbers of loops 20 may be incorporated.

The strap elements 28 are made from flexible, non-elastic material, such as nylon mesh. In other versions, cord, rope or other flexible, non-elastic natural and man-made materials could be used. Each mated portion 30 in this version are formed by the two strap elements 28 being stitched together. Furthermore, at the tail 32 (which is the distal end of the assembly-half 16), the two strap elements 28 are also stitched together to form a secure portion for the user to grasp. If stitching is not desired, rivets, chemical, thermal or other mechanical means well known in the art could be employed.

The loops 20 are made large enough to easily accommodate an average person's hand or lower arm or foot therein—as such, they will generally function as handles or locations to tie elastic bands to. FIG. 4 depicts one use case for this invention.

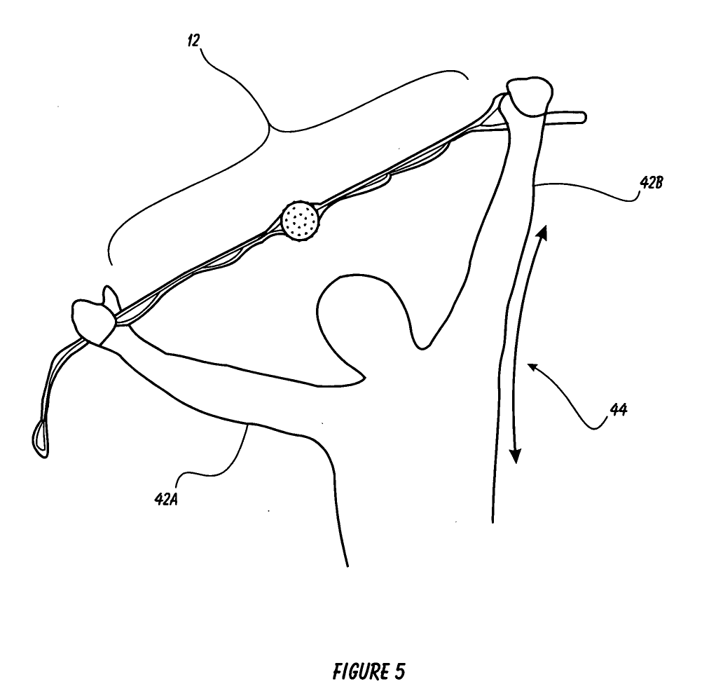

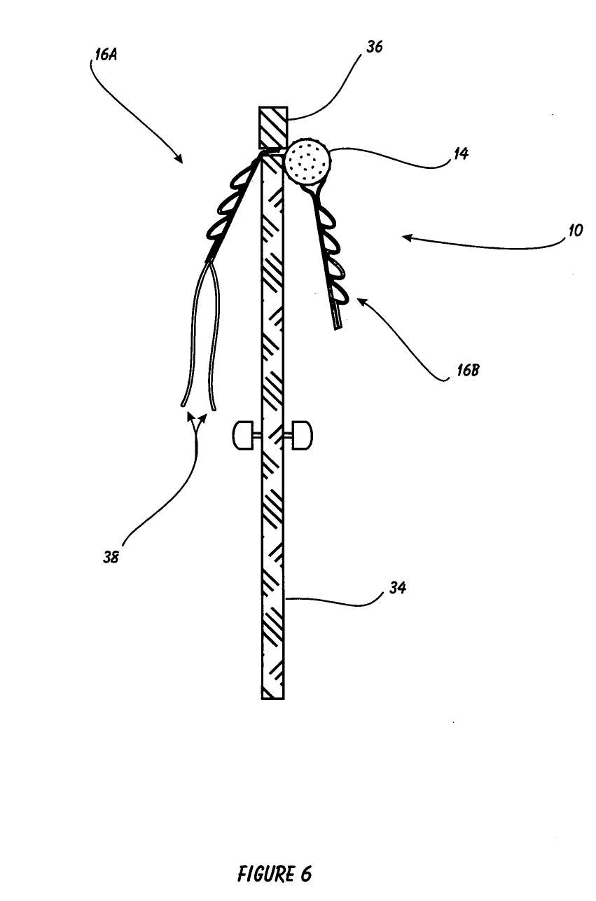

FIG. 4 is a back view of a user employing the apparatus of FIG. 1 to massage himself. As shown, it is a simple matter for the user to slip one hand through a loop 20 in each assembly-half 16. By putting tension on the strap assembly 12, the user forces the spherical member 14 against his neck. The user then simple pulls the strap assembly 12 back and forth to give himself an effective massage to the back of his neck. This procedure can be easily replicated at other locations on the user's body. The bumps formed in the surface of the substantially solid-cored member 14 will provide very soothing agitation and massage at the point of contact of the sphere with the user's body. In FIG. 5, we can see another use case for the present invention.

FIG. 5 is a back view of a user employing the apparatus of FIG. 1 to stretch. Here, the user grasps the strap assembly 12 by its two ends (or slips his hands through two loops), and then drops one arm down, while keeping the elbows straight. The result is to force the other outstretched arm over his head, until adequate pull and stretching is felt at the targeted muscle group 44. A similar approach and/or including twisting of the torso will provide stretching to other muscle groups. FIG. 6 depicts yet another use case.

FIG. 6 is a side view of the apparatus 10 of FIG. 1 as it might be used as a strengthening device. Because the strap assembly 12 is wide and narrow, it will fit between a conventional door 34 and the door frame 36. The user need simply to open the door 34, and then drape or feed the spherical member 14 and the second assembly-half over the other side of the door 34. The user then closes the door 34, thereby capturing the spherical member 14 on the other side.

The user then ties or otherwise attaches an elastic member 38, such as a length of elastic surgical tubing to the tail 32 or one of the loops 20 of the first assembly-half 16A. The elastic member 38 can then be used as a source of resistance in strengthening exercises. For example, the user could face the door 34, place one hand against the door 34, and grasp the elastic member 38 with the remaining free hand. If the user then pulls backwards, or away from the door with the hand grasping the elastic member 38, he or she will receive a muscle strengthening workout to his or her triceps muscle and related muscle group. Similarly, many other muscles and muscle groups could be exercised.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A stretching, strengthening and massage apparatus, comprising:
a strap assembly defining a midpoint and a pair of assembly-halves extending therefrom; and
a spherical member attached to said strap assembly at said midpoint.

2. The apparatus of claim 1, wherein:
said strap assembly is further defined by a central loop formed therein; and
said spherical member attaches to said strap assembly at said central loop.

3. The apparatus of claim 2, wherein each said strap assembly-half comprises a plurality of loops formed therealong.

4. The apparatus of claim 3, wherein said spherical member is further defined by an outer surface and an inner core, said outer surface defined by a pair of apertures formed therethrough, said apertures leading to a strap bore formed in said core, said strap assembly passing through said pair of apertures and said strap bore.

5. The apparatus of claim 4, wherein said outer surface of said spherical member is defined by a plurality of bumps formed thereon and extending outwardly therefrom.

6. The apparatus of claim 5, wherein said strap assembly comprises a first strap element and a second strap element, said first strap element attached to said second strap element to form said loops between mated portions between said first and second strap elements.

7. The apparatus of claim 6, wherein said central loop is formed between a pair of said mated portions between said first and second strap elements.

8. The apparatus of claim 7, wherein said spherical member comprises a pair of said strap bores in parallel spaced relation, each said bore passing through said core and through said apertures formed in said surface.

9. The apparatus of claim 8, wherein said first strap element passes through one said strap bore and said second strap element passes through the other said strap bore, said strap portions passing through said spherical element forming a portion of said central loop.

10. A combination, comprising:
a stretching, strengthening and massage apparatus, comprising:
a strap assembly defining a midpoint and a pair of assembly-halves extending therefrom each said assembly-half terminating in a distal end; and
a spherical member attached to said strap assembly at said midpoint; and
an elongate elastic member attached adjacent to one said distal end.

11. The combination of claim 10, wherein:
said strap assembly is further defined by a central loop formed therein; and
said spherical member attaches to said strap assembly at said central loop.

12. The combination of claim 11, wherein said spherical member is further defined by an outer surface and an inner core, said outer surface defined by a pair of apertures formed therethrough, said apertures leading to a strap bore formed in said core, said strap assembly passing through said pair of apertures and said strap bore.

13. The combination of claim 12, wherein each said strap assembly-half comprises a plurality of loops formed therealong in spaced relation.

14. The combination of claim 13, wherein said strap assembly comprises a first strap element and a second strap element, said first strap element attached to said second strap element to form said loops between mated portions between said first and second strap elements.

15. The combination of claim 14, wherein said spherical member comprises a pair of said strap bores in parallel spaced relation, each said bore passing through said core and through said apertures formed in said surface.

16. The combination of claim 15, wherein said first strap element passes through one said strap bore and said second strap element passes through the other said strap bore, said strap portions passing through said spherical element forming a portion of said central loop.

17. The combination of claim 16, wherein said outer surface of said spherical member is defined by a plurality of bumps formed thereon and extending outwardly therefrom.

18. An exercise device, comprising:
a strap assembly comprising a first strap element mated to a second strap element at a plurality of spaced locations along said strap elements, said second strap element defining a length that is in excess of the length defined by said first strap element; and
a spherical member attached to said first and second strap elements substantially centered along said lengths and further between two said mated locations.
